(19) United States
(12) Patent Application Publication
(10) Pub. No.: US 2026/0203854 A1
(43) Pub. Date: Jul. 16, 2026

(54) POINT CLOUD ALIGNMENT AND COMBINATION FOR VEHICLE APPLICATIONS

(71) Applicant: QUALCOMM Incorporated, San Diego, CA (US)

(72) Inventors: Kuan Hu, Chengdu (CN); Li Sun, Chengdu (CN); Ligang Zeng, Chengdu (CN)

(21) Appl. No.: 19/137,971

(22) PCT Filed: Feb. 23, 2023
(86) PCT No.: PCT/CN2023/077791

§ 371 Date: Jun. 11, 2025

(51) Int. Cl. G06T 3/14; G06T 7/33

(52) U.S. Cl. CPC G06T 3/14; G06T 7/33; G06T 2207/10028

(57) ABSTRACT

Systems, methods, and devices for vehicle driving assistance systems that support image processing are provided. In a first aspect, a computing device (402) may receive a first point cloud (404) and a second point cloud (406). The first and second point clouds may be captured from at least two different positions. The computing device (402) may determine, based on the first and second point clouds, a transformation matrix (412) and may determine an combined point cloud (414) based on the transformation matrix (412) and the first and second point clouds. Other aspects and features are also claimed and described.

### TECHNICAL FIELD

Aspects of the present disclosure relate generally to driver-operated or driver-assisted vehicles, and more particularly, to methods and systems suitable for supplying driving assistance or for autonomous driving.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road.

In one aspect of the disclosure, a method includes receiving a first point cloud and a second point cloud, where the first and second point clouds are captured from at least two different positions. The method also includes determining, based on the first and second point clouds, a transformation matrix. The method also includes determining an aligned point cloud by applying the transformation matrix to the first point cloud, where the aligned point cloud is aligned with the second point cloud. The method also includes determining a combined point cloud for an area containing the at least two different positions based on the aligned point cloud and the second point cloud.

In an additional aspect of the disclosure, a method includes receiving a first point cloud and a second point cloud, where the first and second point clouds are captured from at least two different positions, and where the first and second point clouds contain points with corresponding semantic information. The method also includes determining correspondences of nearby points between the first point cloud and the second point cloud, where the correspondences are identified to contain points whose semantic information indicate corresponding categories. The method also includes determining a weighted combination of the correspondences of nearby points, where weights for the correspondences are determined based on the corresponding categories for the points contained within the correspondences. The method also includes determining a transformation matrix based on the weighted combination of the correspondences of nearby points. The method also includes determining a combined point cloud based on the transformation matrix, the first point cloud, and the second point cloud.

In an additional aspect of the disclosure, an apparatus includes at least one processor and a memory coupled to the at least one processor. The at least one processor is configured to perform operations including receiving a first point cloud and a second point cloud, where the first and second point clouds are captured from at least two different positions, and where the first and second point clouds contain points with corresponding semantic information. The operations also include determining correspondences of nearby points between the first point cloud and the second point cloud, where the correspondences are identified to contain points whose semantic information indicate corresponding categories. The operations also include determining a weighted combination of the correspondences of nearby points, where weights for the correspondences are determined based on the corresponding categories for the points contained within the correspondences. The operations also include determining a transformation matrix based on the weighted combination of the correspondences of nearby points. The operations also include determining a combined point cloud based on the transformation matrix, the first point cloud, and the second point cloud.

In another aspect, a method includes receiving a first point cloud and a second point cloud, where the first and second point clouds are captured from at least two different positions. The method also includes determining a plurality of windows that contain overlapping portions of the first point cloud and the second point cloud. The method also includes determining additional windows that contain different overlapping portions of the first point cloud and the second point cloud based on the first window. The method also includes determining correspondences of nearby points between the first point cloud and the second point cloud, where the correspondences contain points from a single window of the plurality of windows. The method also includes determining a transformation matrix based on the correspondences of nearby points. The method also includes determining a combined point cloud based on the transformation matrix, the first point cloud, and the second point cloud.

In an additional aspect of the disclosure, a non-transitory computer-readable medium stores instructions that, when executed by a processor, cause the processor to perform operations. The operations include receiving a first point cloud and a second point cloud where the first and second point clouds are captured from at least two different positions. The operations also include determining a plurality of windows that contain overlapping portions of the first point cloud and the second point cloud. The operations also include determining additional windows that contain different overlapping portions of the first point cloud and the second point cloud based on the first window. The operations also include determining correspondences of nearby points between the first point cloud and the second point cloud, where the correspondences contain points from a single window of the plurality of windows. The operations also include determining a transformation matrix based on the correspondences of nearby points. The operations also include determining a combined point cloud based on the transformation matrix, the first point cloud, and the second point cloud.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIGS. 4A-4C depict systems for aligning and combining point clouds according to exemplary embodiments of the present disclosure.

FIG. 5A depicts a scenario according to an exemplary embodiment of the present disclosure.

FIG. 5B depicts combined point clouds according to an exemplary embodiment of the present disclosure.

FIG. 5C depicts point clouds 540, 542 according to an exemplary embodiment of the present disclosure.

FIG. 5D depicts point clouds 540, 542 according to an exemplary embodiment of the present disclosure.

FIG. 6 is a flow chart illustrating an example method for aligning and combining point clouds according to an exemplary embodiment of the present disclosure.

FIG. 7 is a flow chart illustrating an example method for aligning and combining point clouds according to an exemplary embodiment of the present disclosure.

FIG. 8 is a flow chart illustrating an example method for aligning and combining point clouds according to an exemplary embodiment of the present disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support aligning and combining multiple point clouds. To combine two point clouds, existing techniques may need to generate a probability model for each point, which may requires dense points, which may not be available in all situations. These techniques may also use the probability model to filter out inaccurate or unreliable data points, which may require a lot of calculations and high memory consumption. These techniques are also subjected to failure modes such as occlusion and differences in viewing angles. This can increase the search space for corresponding points, which may require even further calculations and computing resources. Furthermore, point clouds from different sensors or different positions/trajectories may suffer from scale drift (detailed further below). Scale drift may cause positional errors or inconsistencies between the point cloud, and may differ for different portions of the point clouds. Thus, the same transformation matrix may not be adequate to align all of the point clouds.

One solution to this problem is to use the semantic information for points within a point cloud to limit the search space for corresponding points. For example, correspondences may only be identified between points in the two point clouds that have the same category or similar categories. This may reduce the search space and prevents false positives between different categories, while also reducing the computational intensity of identifying corresponding points. The categories (and their corresponding points) may also be allocated a weight, which may serve as an estimation of how likely the corresponding points are to reflect accurate position information. A transformation matrix may then be generated based on the weighted correspondences and used to align the point clouds.

In situations with significant scale drift, one solution is to utilize varying windows between two or more point clouds to generate transformation matrices for different portions of the point clouds. The transformation matrices may then be used to align different portions of the point clouds, thus correcting for scale drift throughout the point clouds. Furthermore, a framework based on nonlinear optimization and piece-wise point cloud registration may be used to ensure that the transformation matrices are consistent with one another, such that a final aligned and combined point cloud smoothly combines data points from the point clouds while also correcting for scale drift. In certain instances, a first window may be identified based on adequate point density and number of points and may be used to guide the determination of transformation matrices for adjacent windows.

Particular implementations of the subject matter described in this disclosure may be implemented to realize one or more of the following potential advantages or benefits. In some aspects, the present disclosure provides techniques for image processing that may be particularly beneficial in smart vehicle applications. For example, by focusing on determining correspondences between points from the same categories, the above techniques reduce the risks of false positives and other types of inaccurate correspondences. This may increase the accuracy and efficacy of resulting transformation matrices and the associated combined point clouds. Furthermore, by limiting the search space for corresponding points, the above techniques may reduce the computing resources necessary to identify the correspondences and thus to determine combined point clouds. Additionally, weighting the correspondences while determining the transformation matrix reduce the risk that large objects will dominate the analysis, while also increasing the effect that more accurate points have on the resulting transformation matrix. This may similarly increase the accuracy and efficacy of the resulting transformation matrices and the associated combined point clouds and may improve the processing and combination of point clouds that do not have a high density of points. In addition, the above techniques may show improved with changing environmental conditions (such as light conditions, seasonality, weather etc.), because those high weighted categories and correspondences may be more consistent in such conditions.

As another example, these techniques may improve the correction of errors in positional information within point clouds, such as the positional errors that may be caused by scale drift. Furthermore, these techniques preserve internal consistency within transformation matrices, which may help improve the quality of interior relations and positions between objects within point clouds. Such techniques accordingly enable more accurate positional information within combined point clouds, enabling more accurate representations of physical environments for subsequent use in vehicle applications. Furthermore, by adaptively sizing each window within the point clouds, these techniques reduce the overall amount of computing resources necessary to acquire accurate comparisons between windows, enabling more efficient processing of point clouds with internally varying point densities.

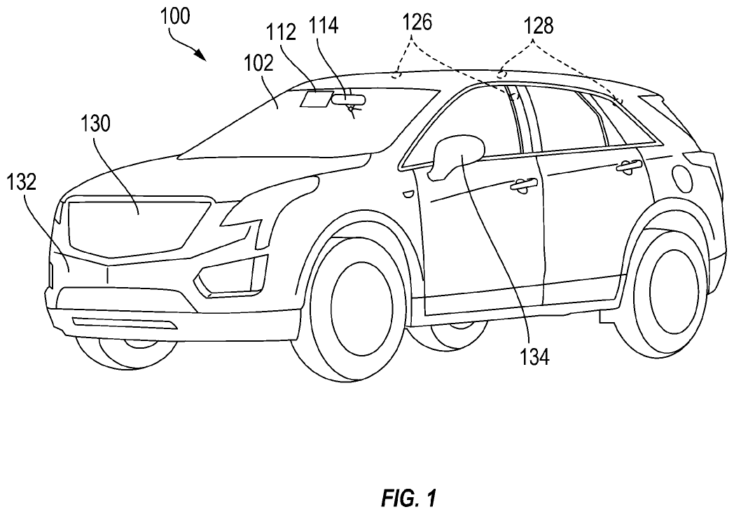

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or in a forward direction. In some embodiments, an additional camera may be located at the rear of the vehicle 100 and oriented such that the field of view of the additional camera captures a scene behind the vehicle 100 in the direction that the vehicle 100 is moving when in reverse mode or in a reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the vehicle 100 is traveling in a forward direction may likewise be obtained while the vehicle 100 is traveling in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

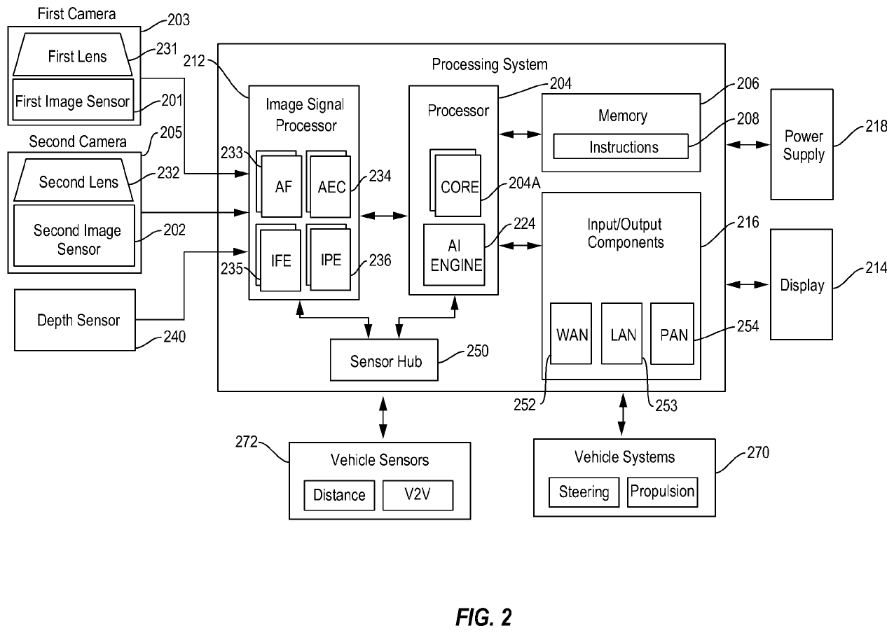

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination).

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

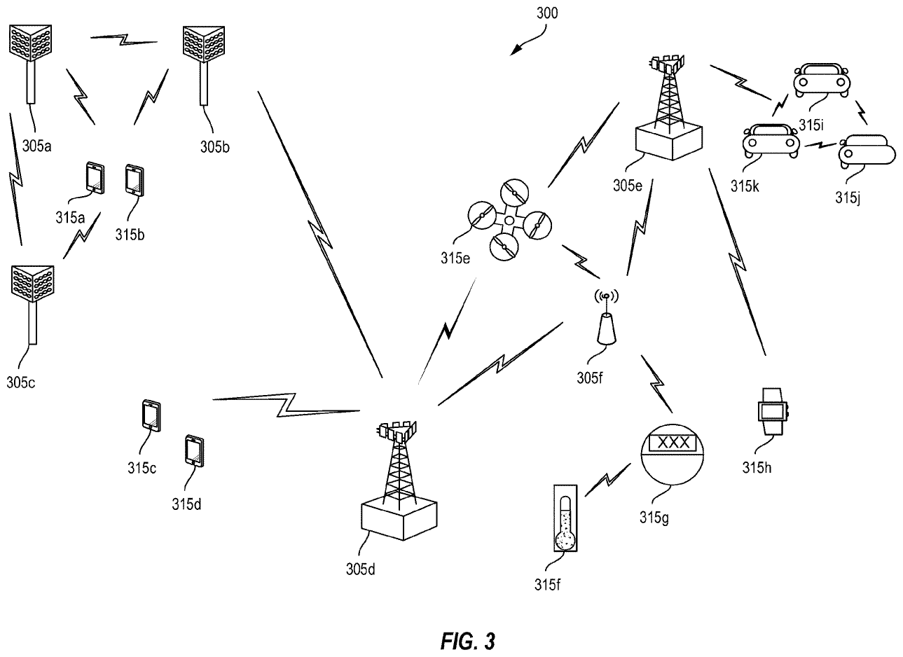

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports mission critical communications with ultra-reliable and redundant links for mission critical devices, such UE 315e, which is a drone. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305e.

Aspects of the vehicular systems described with reference to, and shown in, FIG. 1, FIG. 2, and FIG. 3 may include aligning multiple point clouds into a single, combined point cloud, which may be used for subsequent vehicle applications.

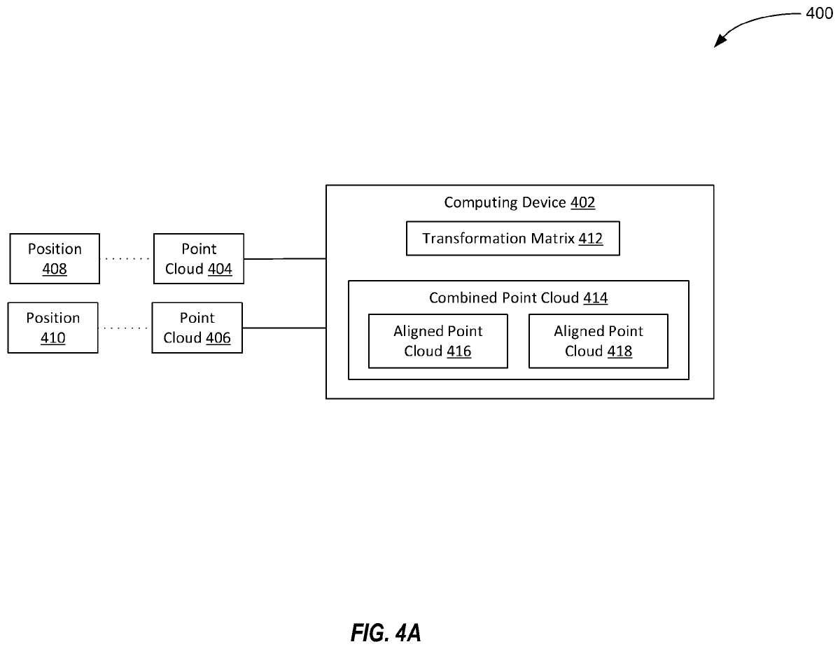

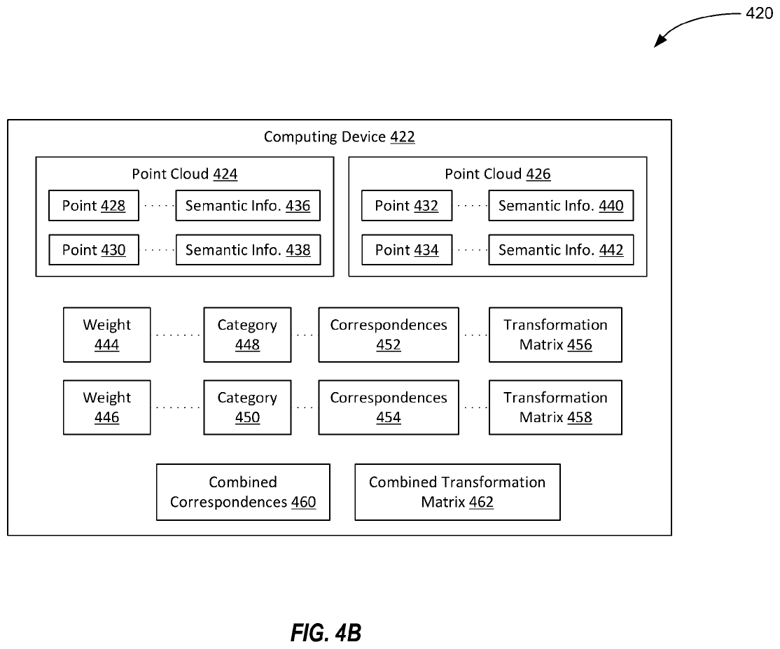

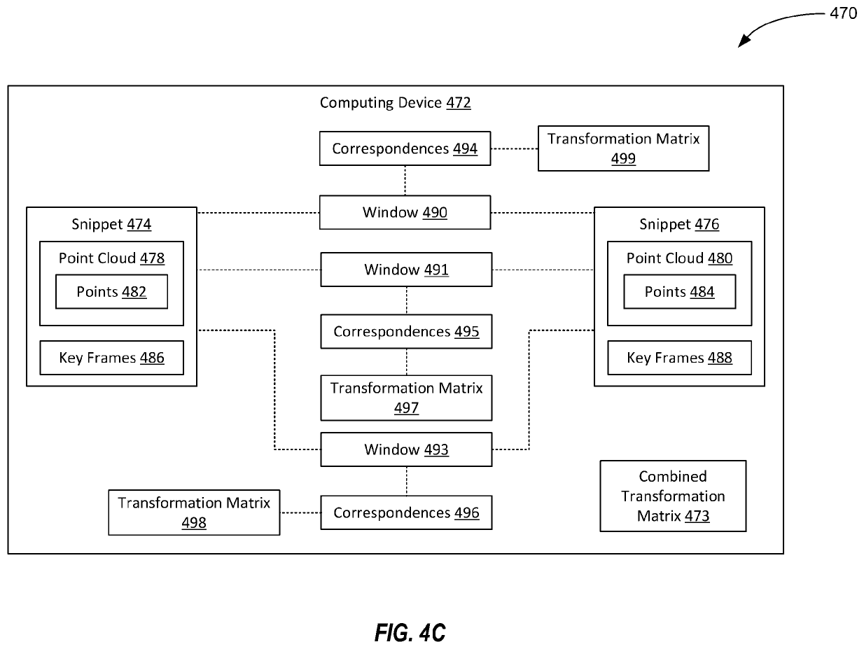

FIG. 4A is a block diagram illustrating a system 400 for aligning and combining point clouds according to an exemplary embodiment of the present disclosure. The system 400 includes a point clouds 404, 406, positions 408, 410, and a computing device 402. The computing device 402 includes a transformation matrix 412, and a combined point cloud 414, which includes aligned point clouds 416, 418.

In particular, the computing device 402 may be configured to receive a plurality of point clouds 404, 406 containing position information for a scene. The scene may include a physical area, such as a road and surrounding objects. In certain implementations, the point clouds 404, 406 may be received by another computing device, or another process executing on the computing device 402 that is configured to determine that the point clouds 404, 406 contain information regarding the same area. In certain instances, the point clouds 404, 406 may be determined from different viewpoints, such as from vehicles travelling in different directions or vehicles travelling in different lanes. In certain implementations, the plurality of point clouds 404, 406 may contain position information for one or more objects within the area. For example, the point clouds 404, 406 may contain points that contain position information, such as a measured position of an object located at the point by a vehicle. In certain implementations, the points may be voxels that contain three-dimensional positional coordinates of objects within the scene.

In certain implementations, the point clouds 404, 406 may further contain semantic information regarding the objects corresponding to the points, such as semantic information for an object located at the corresponding position identified by a point. In certain implementations, the semantic information may indicate one or more corresponding categories, types, classifications, or other identifiers of objects located at positions corresponding to the points within the point cloud. In certain implementations, the categories may include buildings, structures (such as bridges, ramps, and the like), signage, traffic signals, road markings, lanes, and the like.

In certain implementations, the point clouds 404, 406 may be received as part of corresponding snippets. The snippets may contain the point clouds 404, 406 and key frames used to determine the point clouds 404, 406. In particular, snippets may represent a subset of a three-dimensional (3D) model, such as a 3D road database model. The point clouds may be corresponding 3D positional data from portions of the 3D model. The 3D positional data may be generated from image frames (such as a video sequence of image frames captured from a moving vehicle) and other sensor data (such as radar, LIDAR, ultrasonic, and/or other positional sensors on a vehicle). In certain implementations, different point clouds 404, 406 may be determined based on different types of sensor data, or different combinations of sensor data. The data used may be embodied in the key frames, which may represent points along a path or trajectory traveled by a vehicle and may contain corresponding image or other sensor data captured at or near that location. In certain implementations, the key frames may additionally or alternatively contain processed data generated based on sensor data captured by a vehicle. For example, the key frames may include camera pose information for an image sensor on the vehicle at corresponding positions, two-dimensional feature points for objects in the scene, and/or relationships between two-dimensional feature points (such as relationships between feature points corresponding to different frames within the same set of key frames).

The computing device 402 may be configured to determine, based on the plurality of point clouds 404, 406, a transformation matrix 412. For example, and as explained further below, the transformation matrix 412 may be determined by identifying correspondences between position information (such as points from the point clouds 404, 406) for the same objects in different point clouds 404, 406. The transformation matrix 412 may then be determined to reverse or otherwise compensate for the differences in position. Correspondences may be identified using various strategies. For example, correspondences may be identified based on semantic information for the points within the point clouds 404, 406. As another example, different correspondences may be identified for different windows identifying subsets of the scene (and corresponding subsets of the point clouds 404, 406).

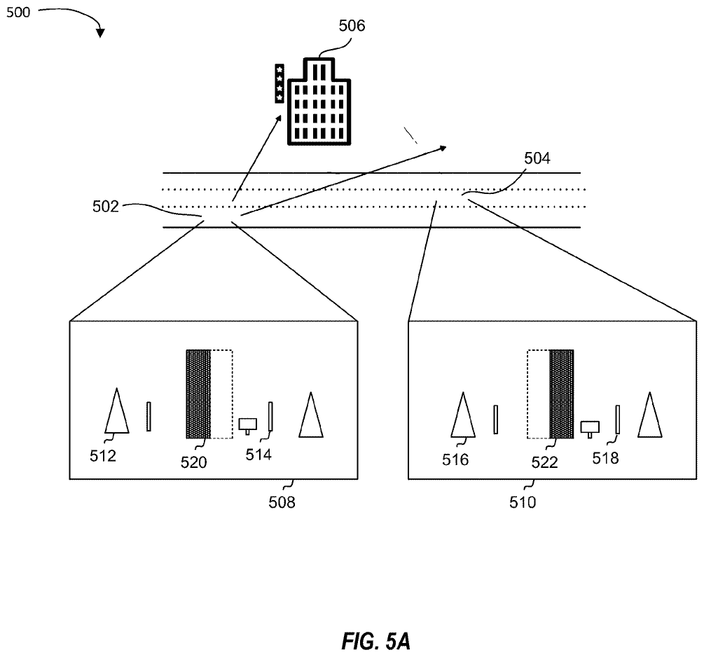

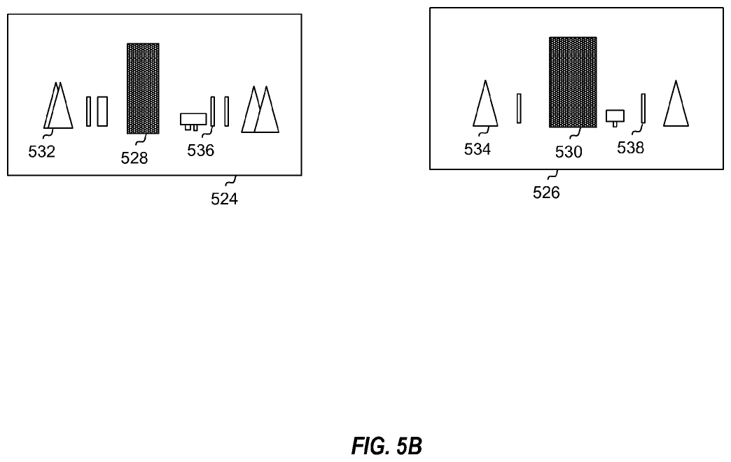

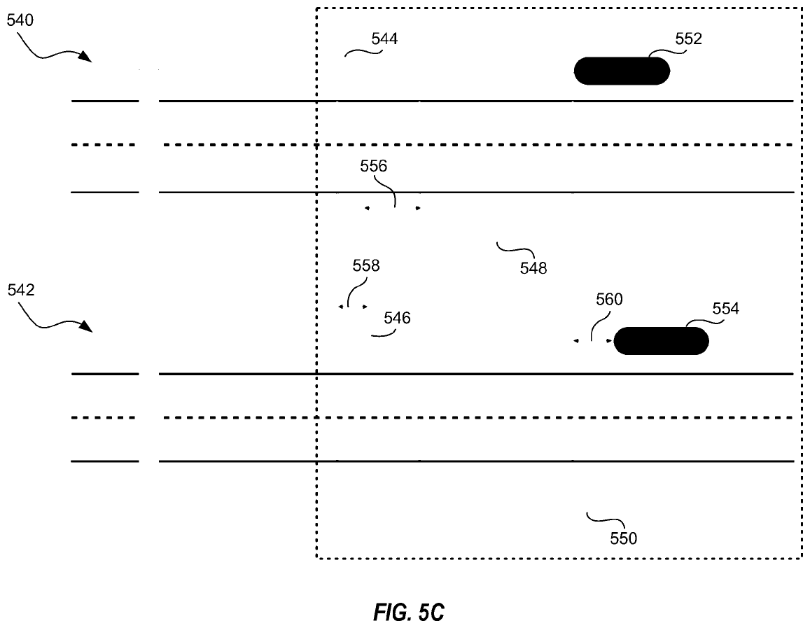

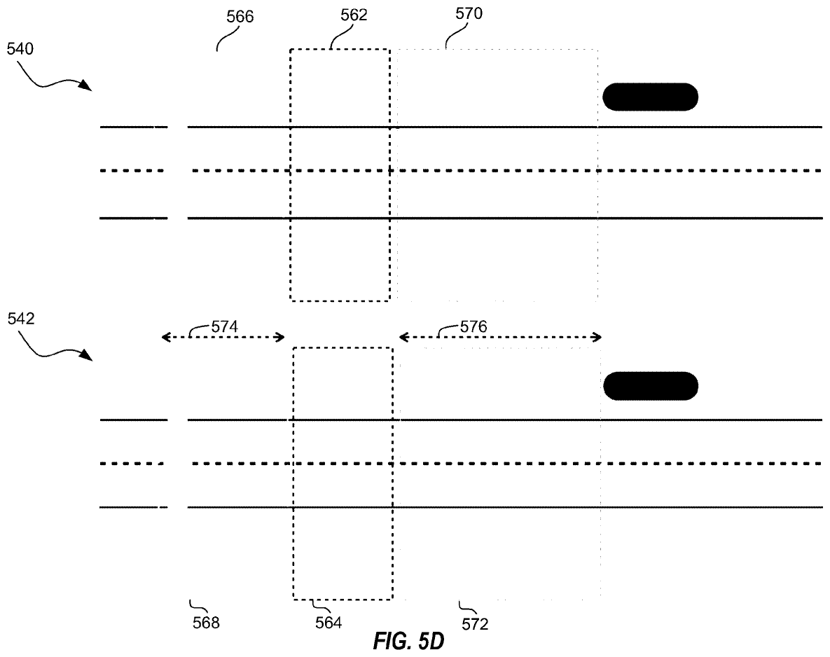

The computing device 402 may be configured to determine an aligned point cloud 416 by applying the transformation matrix 412 to the first point cloud 404. In certain implementations, the aligned point cloud 416 may be aligned with the second point cloud 406. In further instances, the transformation matrix 412 (or another transformation matrix) may be applied to the second point cloud 406 to generate an aligned point cloud 418. In such instances, the aligned point cloud 418 may be aligned with the aligned point cloud 416, such that positions of objects within the aligned point cloud 418 align with positions of the same objects within the aligned point cloud 416. For example, FIG. 5A depicts a scenario 500 according to an exemplary embodiment of the present disclosure. In the scenario 500, a point cloud 508 detected by a first vehicle 502 (such as from a first position or a first trajectory) differs from the point cloud 510 from a second vehicle 504 (such as from a second position or a second trajectory). In particular, the scenario 500 includes a building 506, and the point cloud 508 only contains a representation 520 of the left half of the building 506 and the point cloud 510 only contains a representation 522 of the right half of the building 506. The point clouds 508, 510 have representations 512, 514, 516, 518 of other objects within the scenario 500, such as trees, poles, and signs. These objects are smaller and may therefore be more accurately represented within the point clouds 508, 510.

The computing device 402 may be configured to determine a combined point cloud 414 for an area containing the at least two different positions 408, 410 based on the aligned point clouds 416, 418. For example, position information from the aligned point clouds 416, 418 may be combined together to form the combined point cloud 414. The combined point cloud 414 may then be used for vehicle applications, such as vehicle monitoring and/or guidance. For example, FIG. 5B depicts combined point clouds 524, 526 according to an exemplary embodiment of the present disclosure. When combining different point clouds (such as the point clouds 508, 510) into a combined point cloud, various errors may be introduced. For example, large objects (such as the building 506) may have more points within the point clouds 508, 510, and may dominate when transforming the point clouds 508, 510 into a combined point cloud 524, 526. In particular, the combined point cloud 524 has a representation 528 of the building 506 that is too small relative to the size of the building 506, and has duplicated representations 532, 536 of other objects because of an improper. By contrast, a proper combined point cloud 526 (such as a combined point cloud generated according to one of the presently-discussed techniques) should include a single, properly-scaled representation 530 of the building 506 and individual representations 534, 538 of other objects.

FIG. 4B depicts a system 420 for aligning and combining point clouds according to an exemplary embodiment of the present disclosure. The system 420 includes a computing device 422, which includes point clouds 424, 426, categories 448, 450, correspondences 452, 454, transformation matrices 456, 458, weights 444, 446, combined correspondences 460, and a combined transformation matrix 462. The point clouds 424, 426 include points 428, 430, 432, 434 and corresponding semantic information 436, 438, 440, 442. The system 420 may be an exemplary implementation of the system 400. For example, the computing device 422 may be an exemplary implementation of the computing device 402, the point clouds 424, 426 may be exemplary implementations of the point clouds 404, 406, and the combined transformation matrix 462 may be an exemplary implementation of the transformation matrix 412.

The computing device 422 may be configured to receive a first point cloud and a second point cloud. In certain instances, the first and second point clouds 424, 426 are captured from at least two different positions. In such instances, the first and second point clouds 424, 426 contain points 428, 430, 432, 434 with corresponding semantic information 436, 438, 440, 442. In certain implementations, the semantic information 436, 438, 440, 442 may include information regarding objects whose positions are indicated by the corresponding points 428, 430, 432, 434. For example, as noted above, the semantic information 436, 438, 440, 442 may indicate one or more corresponding categories or other identifiers of objects located at the measured positions used to generate the points 428, 430, 432, 434 within the point cloud 424, 426. For example, categories may include buildings, road structures, road markings, vegetation, other structures, road signage, other signage, and the like. In various implementations, the categories may be defined in different levels of details. For instance, the categories may include specific types of objects. Continuing the previous example, the categories may include specific types of building (such as houses, apartment buildings, utility buildings, office building, and the like), specific types of road structures (such as curbs, dividers, medians, turning lanes, and the like), specific types of road markings (such as dashed lines, solid lines, bike lane markers, turning lane markers, and the like), specific types of vegetation (such as bushes, trees, and the like), specific types of other structures (such as poles, bridges, ramps, and the like), specific types of road signage (such as road identifiers, traffic signals, traffic signs, speed limit signs, and the like), specific types of other signage (such as business signage, fast food signage, and the like. In certain implementations, the semantic information 436, 438, 440, 442 may be determined using one or more image processing techniques, such as Deep Learning Semantic Segmentation. In certain implementations, the semantic information 436, 438, 440, 442 may be included with the points 428, 430, 432, 434 as part of the point cloud 424, 426 (such as part of a snippet containing the point clouds 424, 426).

The computing device 422 may be configured to determine correspondences 452, 454 of nearby points 428, 430, 432, 434 based on the first point cloud 424 and the second point cloud 426. The correspondences 452, 454 may be identified to contain points 428, 430, 432, 434 from two or more point clouds 404, 406 whose semantic information 436, 438, 440, 442 indicate corresponding categories 448, 450 (such as the same category). In particular, correspondences 452, 454 may be collections of two or more points from different point clouds 424, 426 that correspond to the same object within (such as the same physical object) in a physical area corresponding to the scene. As one specific example, a correspondence may be identified between the point 428 of the point cloud 424 and the point 432 of the point cloud 426. In certain implementations, corresponding categories 448, 450 include groups of one or more categories 448, 450 of objects identified by the semantic information 436, 438, 440, 442. For example, corresponding categories may include categories that indicate the same or similar type of object, such as categories of the semantic information 436, 438, 440, 442 that are likely to be positioned close to one another (such as within a typical scene or physical area). In certain implementations, groups or collections of corresponding categories may be predetermined, such as according to a taxonomy of categories for the semantic information 436, 438, 440, 442. For example, in certain implementations all “building” categories may be considered corresponding categories, including categories that identify different types of buildings. In additional or alternative implementations, certain types of buildings may be considered corresponding categories (such as utility building and office buildings). In still further implementations, the same category may be required to identify corresponding categories (such as the “office building” category may only correspond with itself).

In certain implementations, identifying the correspondences 452, 454 of nearby points 428, 430, 432, 434 may include determining, based on categories 448, 450 identified in the semantic information 436, 438, 440, 442, groups of points 428, 430, 432, 434 from the first point cloud 424 and the second point cloud 426 that have corresponding categories 448, 450. In such instances, for each group of points 428, 430, 432, 434, correspondences 452, 454 may be identified by identifying closest points 428, 430, 432, 434 between the first point cloud 424 and the second point cloud 426 from the respective group. In certain implementations, an iterative closest points analysis may be performed based on a first set of points from the first point cloud 424 and a second set of points from the second point cloud 426 (where both the first and second sets of points share corresponding categories) to determine the correspondences 452, 454. As a particular example, a fast library for approximating nearest neighbor (FLANN) tree will be established and searched to find correspondences 452, 454 of two or more points from the point clouds 424, 426. The correspondences 452, 454 may then be sorted according to the distance between the points, and a filter (such as a median filter) may used to remove those outliers (such as outliers with the largest distances between identified points). In certain implementations, correspondences 452, 454 may have a single point from each of at least a subset of the point clouds 424, 426 (such as one point from the point cloud 424 and one point from the point cloud 426). In additional or alternative implementations, the correspondences 452, 454 may have more than one point from at least one of the subset of the point clouds 424, 426 (such as one point from the point cloud 424 and two points from the point cloud 426).

The computing device 422 may be configured to determine a weighted combination of the correspondences 452, 454 of nearby points 428, 430, 432, 434. In certain implementations, the weights 444, 446 for the correspondences 452, 454 may determined based on the corresponding categories 448, 450 for the points 428, 430, 432, 434 contained within the correspondences 452, 454. In particular, the computing device 422 may determine separate sets of one or more correspondences 452, 454 that correspond to each category 448, 450 (such as sets of corresponding categories). Each category 448, 450 may also have a corresponding weight 444, 446, which may be predetermined.

In certain implementations, the weights 444, 446 may reflect a relative positional accuracy of points 428, 430, 432, 434 corresponding to different types of objects. For example, man-made objects (such as buildings, other structures) may generally have simpler surfaces and shapes than natural objects (such as vegetation) and thus more accurate position information, and weights corresponding to categories of man-made objects may accordingly be weighted higher than natural objects. As another example, objects that are typically closer to a road (such as road signage, road structures) may typically have more accurate position information than objects that are typically located further from the road (such as buildings). Accordingly, weights associated with categories of objects that are typically located closer to the road may typically be higher than weights associated with objects that are typically located further from the road. As a further example points for larger objects (such as buildings, vegetation) may be more easily affected by lighting conditions, weather, or occlusions, which can cause incomplete coverage of the objects and less accurate position information. Accordingly, categories of larger objects (such as buildings, vegetation) may be weighted lower than categories of smaller objects (such as road signage, other structures, road structures).

The weighted combination may be determined by multiplying correspondences 452, 454 by their corresponding weights 444, 446 to form weighted correspondences. The weighted correspondences may then be collected or otherwise combined to form a set of combined correspondences 460.

The computing device 422 may be configured to determine a transformation matrix based on the weighted combination of the correspondences 452, 454 of nearby points 428, 430, 432, 434. For example, the computing device 422 may determine a combined transformation matrix 462 based on the correspondences 452, 454 and their corresponding weights 444, 446. In certain implementations, the transformation matrix 462 may be determined based on the combined correspondences 460. For example, the transformation matrix 462 may be determined to satisfy an error function that penalizes distances between points within the same correspondence (such as according to the corresponding weight 444, 446). As a specific example, the error function may be defined as:

$$T = arg min {\sum }_{i = 1}^{n} {ω}_{i} ‖ {p}_{s} - T ( {p}_{t} ) ‖$$

where T is the transformation matrix 462, wᵢ is the weight for correspondence i, n is the number of correspondences 452, 454, pₛ is a point in a first point cloud (such as a “source” point cloud 424), and pₜ is a point in a second point clouds (such as a “target” point cloud 426).

In certain implementations, separate transformation matrices 456, 458 may be determined for each category (or group of corresponding categories). For example, a first transformation matrix 456 may be determined based the correspondences 452 for the category 448 and a second transformation matrix 458 may be determined based on the correspondences 454 for the category 450. In such instances, each of the transformation matrices 456, 458 may be determined based on an error function similar to the one discussed above. The separate transformation matrices 456, 458 may then be combined to form the combined transformation matrix 462. For example, each transformation matrix 456, 458 may be multiplied by the corresponding weight 444, 446 and combined to form the combined transformation matrix 462. In such implementations, the computing device 422 may not determine the weighted combination of correspondences 460.

The computing device 422 may be configured to determine a combined point cloud for the scene (such as a physical area containing the detected objects). The combined point cloud may be determined based on the point clouds 424, 426 and the transformation matrix 462. For example, the combined transformation matrix 462 may be an exemplary implementation of the transformation matrix 412, and the computing device 422 may determine the combined point cloud similar to the techniques discussed above in connection with the combined point cloud 414. In certain instances, a fitness score may be generated that indicates how well the point clouds 424, 426 align based on the combined transformation matrix 462. For example, the fitness score may be computed as the average distances between points contained within the same correspondences 452, 454.

Accordingly, by focusing on determining correspondences between points from the same categories, the above techniques reduce the risks of false positives and other types of inaccurate correspondences. This may increase the accuracy and efficacy of resulting transformation matrices and the associated combined point clouds. Furthermore, by limiting the search space for corresponding points, the above techniques may reduce the computing resources necessary to identify the correspondences and thus to determine combined point clouds. Additionally, weighting the correspondences while determining the transformation matrix reduce the risk that large objects will dominate the analysis, while also increasing the effect that more accurate points have on the resulting transformation matrix. This may similarly increase the accuracy and efficacy of the resulting transformation matrices and the associated combined point clouds and may improve the processing and combination of point clouds that do not have a high density of points. In addition, the above techniques may show improved with changing environmental conditions (such as light conditions, seasonality, weather etc.), because those high weighted categories and correspondences may be more consistent in such conditions.

FIG. 4C depicts a system 470 for aligning and combining point clouds according to an exemplary embodiment of the present disclosure. The system 470 includes a computing device 472, which includes snippets 474, 476, windows 490, 491, 493, correspondences 494, 495, 496, transformation matrices 497, 498, 499, and a combined transformation matrix 473. The snippets 474, 476 include point clouds 478, 480 and key frames 486, 488, and the point clouds 478, 480 include points 482, 484. The system 470 may be an exemplary implementation of the system 400. For example, the computing device 472 may be an exemplary implementation of the computing device 402, the point clouds 478, 480 may be exemplary implementations of the point clouds 404, 406, and the combined transformation matrix 473 may be an exemplary implementation of the transformation matrix 412.

The computing device 472 may be configured to receive a first point cloud 478 and a second point cloud 480. The first and second point clouds 478, 480 may be captured from at least two different positions or trajectories. In certain implementations, the point clouds 478, 480 may be received as part of corresponding snippets 474, 476. The snippets 474, 476 may contain the point clouds 478, 480 and key frames 486, 488 used to determine the point clouds 478, 480. For example, the point cloud 478 may be determined based on the key frames 486 and the point cloud 480 may be determined based on the key frames 488. In particular, snippets may represent a subset of a three-dimensional (3D) model, such as a 3D road database model. The point clouds 478, 480 may be corresponding 3D positional data from portions of the 3D model. The 3D positional data may be generated from image frames (such as a video sequence of image frames captured from a moving vehicle) and other sensor data (such as radar, LIDAR, ultrasonic, and/or other positional sensors on a vehicle). The data used may be embodied in the key frames 486, 488, which may represent points along a path or trajectory traveled by a vehicle and may contain corresponding image or other sensor data captured at or near that location. In certain implementations, the key frames 486, 488 may additionally or alternatively contain processed data generated based on sensor data captured by a vehicle. For example, the key frames may include camera pose information for an image sensor on the vehicle at corresponding positions, two-dimensional feature points for objects in the scene, and/or relationships between two-dimensional feature points (such as relationships between feature points corresponding to different frames within the same set of key frames 486, 488). In still further implementations, the key frames 486, 488 may include or otherwise identify corresponding points 482, 484 whose positions were determined based on the particular key frame.

In certain implementations, differences in position data may be caused by different perceived or measured scales for one or more objects within the scene. In particular, one or more objects within the first point cloud 478 may differ in size or scale from corresponding objects within the second point cloud 480. These differences in scale may be known as “scale drift” and may cause a misalignment of the point clouds 478, 480, which may cause issues when the point clouds 478, 480 are combined. For example, FIG. 5C depicts point clouds 540, 542 according to an exemplary embodiment of the present disclosure. The point clouds 540, 542 each contain position data regarding various objects 544, 546, 548, 550, 552, 554 (only a subset of which have corresponding reference numbers). Certain objects within the point clouds 540, 542 may correspond to one another (such as may be present in both point clouds 540, 542). For example, the object 544 may correspond to the object 546, the object 548 may correspond to the object 550, and the object 552 may correspond to the object 554. However, corresponding objects 544, 546, 548, 550, 552, 554 may differ in size and position in the point clouds 540, 542. For example, the object 544 may be a different size in the point cloud 540 than the object 546 is in the point cloud 542. These differences may cause inconsistencies or other errors for positioning data between the point clouds 540, 542, which may create issues when the point clouds 540, 542 are combined. For example, FIG. 5C includes indications of a positioning error 558 for the object 544, 546, a positioning error 556 for the object 548, 550, and a positioning error 560 for the object 552, 554. The positioning errors 556, 558, 560 may represent differences in positions of corresponding objects between the point clouds. The computing device 472 may be configured to detect and correct scale drift, including detecting and correcting for differences in the size and/or position of objects within received point clouds 478, 480.

The computing device 472 may be configured to determine a plurality of windows 490, 491, 493 that contain overlapping portions of the first point cloud 478 and the second point cloud 480. In certain implementations, determining the plurality of windows 490, 491, 493 may include determining a first window 490 that contains overlapping portions of the first point cloud 478 and the second point cloud 480 that each contain more than a predetermined number of points 482, 484. For example, a first portion of the first point cloud 478 may overlap with a second portion of the second point cloud 480, and the first window 490 may contain both the first portion and the second portion. As a specific example, FIG. 5D depicts point clouds 540, 542 according to an exemplary embodiment of the present disclosure. The point clouds 540, 542 may be exemplary implementations of the point clouds 478, 480, and may concern the same scene (such as the same section of a roadway). The point clouds 540, 542 contain portions 562, 564, 566, 568, 570, 572, which may contain subsets of the points from the point clouds 540, 542. Each of the portions 562, 564, 566, 568, 570, 572 may be part of a corresponding window, such as one of the windows 490, 491, 493. For example, the window 490 may be identified to contain the portions 562, 564, the window 491 may be identified to contain the portions 566, 568, and the window 493 may be identified to contain the portions 570, 572.

Returning to FIG. 4C, the computing device 472 may determine additional windows 490, 491, 493 that contain different overlapping portions of the first point cloud 478 and the second point cloud 479 based on the first window 490. In certain implementations, at least a subset of the additional windows 490, 491, 493 may be determined to include portions of the first point cloud 478 and the second point cloud 479 that are not contained within the first window 490. For example, each portion of the first point cloud 478 and the second point cloud 479 may be identified within at least one corresponding window. As a specific example, and returning to FIG. 5D, the first window 490 may contain the portions 562, 564 of the point clouds 540, 542, and additional windows may be identified adjacent to the first window that contain adjacent portions of the point clouds 540, 542. For example, an additional window 491 may be identified that contains the portions 566, 568 of the point clouds 540, 542 and another window 493 may be identified that contains the portions 570, 572 of the point clouds 540, 542. As shown in FIG. 5D, in certain implementations, the windows may be identified as separate windows for each portion of the point cloud 540, 542 (such as where each point of the point clouds 540, 542 are contained by a single corresponding window). In additional or alternative implementations, multiple windows may contain certain points. For example, the windows 491, 493 may be identified as sliding windows moving outward along a direction of travel within the scene from the position of the first window 490 (such as from the position of the portions 562, 564.

In various implementations, the size of the windows 490, 491, 493 may differ. For example, FIG. 5D includes sizes 574, 576 for the portions 568, 572 (which may also represent corresponding sizes for the portions 566, 570). The size 574, 576 of the windows 490, 491, 493 may be defined along a direction of travel within the scene (such as parallel with a road within the scene) to contain more or fewer points from each of the point clouds 478, 480. In certain implementations, sizing the windows 490, 491, 493 may be used to balance between transformation accuracy/reliability and computational resource requirements. For example, windows 490, 491, 493 that are too small may cause unreliable or inaccurate transformations (such as because of less accurate comparisons between corresponding points from the point clouds 478, 480). As another example, windows 490, 491, 493 that are too large may be too computationally intense, which may require more than one transformation to be applied, reducing the likelihood that a single transformation is sufficient for the entire window (which may be required by subsequent processing to generate the combined transformation matrix 473. For example, when determining the windows 490, 491, 493, the computing device 472 may determine that corresponding portions of the point clouds 478, 480 contain more than a predetermined number of points 482, 484. As particular examples, the windows 490, 491, 493 may be determined to contain 100 points, 1000 points, 5000 points, 10000 points, or combinations thereof. In certain implementations, the first window 490 may be identified as the smallest combination of overlapping portions of the first point cloud and the second point cloud that each contain more than the predetermined number of points 482, 484. Similarly, the additional windows 491, 493 may be determined as the smallest combination of overlapping portions of the point clouds 478, 480 adjacent to previous windows (such as the first window) that contain more than the predetermined number of points. In certain implementations, the computing device 472 may also determine that the points 482, 484 are evenly distributed between portions of the point clouds 478, 480 within identified windows 490, 491, 493, such as within a predetermined percentage of the same number of points 482, 484 (such as 10%, 5%, 1%, 0.5%, 0.1%, and the like). In still further implementations, the computing device 472 may determine that the first and second point clouds 478, 480 have a similar density of points within identified point clouds (such as within 10%, 5%, 1%, 0.5%, 0.1% of the same density, and the like). In additional or alternative implementations, the computing device 472 may determine windows 490, 491, 493 may be determined according to a trajectory distance (such as a pose accumulated distances), which may be implemented as a threshold or target window size (such as a window size of 50 meters).

In certain implementations, at least one of the additional windows 490, 491, 493 differs in size from the first window. For example, a density of points 482, 484 within the point clouds 478, 480 may differ for different locations within the point clouds 478, 480. Accordingly, the windows 490, 491, 493 for such regions may be determined, based on the above techniques, to be larger in locations with lower point density and smaller in locations with higher point density, to ensure that enough points 482, 484 are included for subsequent analysis.

The computing device 472 may be configured to determine correspondences 494, 495, 496 of nearby points 482, 484 between the first point cloud 478 and the second point cloud 480. The correspondences 494, 495, 496 may contain points 482, 484 from the same windows 490, 491, 493 of the plurality of windows 490, 491, 493. For example, the correspondences 494 may contain only points from the window 490, the correspondences 495 may contain only points from the window 491, and the correspondences 496 may contain only points from the window 493. In certain implementations, determining the correspondences of nearby points 482, 484 may include determining, for each window 490, 491, 493, correspondences 494, 495, 496 by identifying closest points 482, 484 between the first point cloud and the second point cloud within the respective window. In certain implementations, the correspondences of nearby points 482, 484 may be determined using an iterative closest points (ICP) analysis. In still further implementations, the techniques used to identify the closest points for the correspondences 494, 495, 496 may use techniques similar to those discussed above in connection with determining the correspondences 452, 454.

The computing device 472 may be configured to determine a transformation matrix (such as a combined transformation matrix 473) based on the correspondences 494, 495, 496 of nearby points 482, 484. In certain implementations, the computing device 472 may determine separate transformation matrices 497, 498, 499 for each separate set of correspondences 494, 495, 496. The computing device 472 may then determine the combined transformation matrix 473 based on the separate transformation matrices 497, 498, 499. For example, the computing device 472 may determine correspondences 494 from points within the first window 490 and determine a first transformation matrix 499 based on the correspondences 494 for the first window 490. For example, the transformation matrix 499 may be determined to correct or reverse positional differences between corresponding points within the correspondences 494 (such as similar to determining the transformation matrices 456, 458 based on the correspondences 452, 454). In certain implementations, the computing device 472 may similarly determine the transformation matrices 497, 498 based on the correspondences 495, 496. In additional or alternative implementations, the computing device 472 may determine the transformation matrices 497, 498 at least in part based on the first transformation matrix 499. For example, the computing device 472 may apply the first transformation matrix 499 to points within adjacent windows 491, 493 before determining the correspondences 494, 496 and may then determine the correspondences 494, 496 based on the transformed points from the adjacent windows 491, 493. The transformation matrices 497, 498 may then be determined based on the correspondences 494, 496. Such techniques may improve the accuracy of the transformation matrices 497, 498 for other windows 491, 493 within the point clouds 478, 480. For example, the first window 490 may be identified within a region that has the best point cloud density (such as the highest density of points), and utilizing the first transformation matrix 499 on point clouds for adjacent matrices may improve the accuracy of the identified correspondences, thereby improving the accuracy of the resulting transformation matrices 497, 498. The computing device 472 may iterate outwards along the point clouds 478, 480, in this manner to determine transformation matrices and correspondences for each of at least a subset of the identified windows within the point clouds 478, 480. For example, the transformation matrices 497, 498 may respectively be used on points contained within windows that are adjacent to the windows 491, 493 to determine corresponding transformation matrices for the adjacent windows.

In certain implementations, after determining separate transformation matrices 492, 498, 499, the computing device 472 may determine comparisons between adjacent transformation matrices 497, 498, 499 of the plurality of transformation matrices 497, 498, 499. The adjacent transformation matrices 497, 498, 499 correspond to adjacent windows 490, 491, 493 of the plurality of windows 490, 491, 493. For example, the computing device 472 may compare the transformation matrix 499 for the window 490 to the transformation matrix 497 for the adjacent window 491 and may compare the transformation matrix 499 to the transformation matrix 498 for the adjacent window 493. In certain implementations, the computing device 472 may remove at least a subset of the transformation matrices 497, 498, 499 based on the comparisons. For example, if a first transformation matrix differs too much from an adjacent transformation matrix, the first transformation matrix may be removed. In particular, the computing device 472 may utilize a loop error rejection method to compare and remove the transformation matrices that are not consistent with adjacent results. The loop error rejection method may be a cycle based measurement elimination method configured to ensure the global consistency of all the measurements. Removing inconsistent transformation matrices may ensure consistency and smoothness in the resulting combined transformation matrix 473, which may help avoid discontinuity in a resulting combined point cloud (such as the combined point cloud 414).

In certain implementations, a combined transformation matrix 473 may then be determined based on the remaining transformation matrices 497, 498, 499. For example, the computing device 472 may determine the transformation matrix 473 based on the plurality of transformation matrices 497, 498, 499, the first point cloud 478, and the second point cloud 480. In certain implementations, the computing device 472 may determine the combined transformation matrix 473 using a pose graph optimizer. For example, the computing device 472 may construct a pose graph according to the remaining transformation matrices 497, 498, 499 and may determine the combined transformation matrix 473 based on the pose graph. For example, the computing device 472 may target a final transformation matrix 473 by comparing the smoothness (such as a pose smoothness) of the pose graph for the transformation matrices 497, 498, 499 to a smoothness (such as a pose smoothness) of a pose graph for one or both of the point clouds 478, 480. In such instances, the optimization may be performed to determine whether poses of objects within the resulting combined point cloud can have the same or similar smoothness as poses of objects within the original source point clouds 478, 480. In particular, the combined transformation matrix 473 may be determined to be smooth and free of discontinuities or inconsistences using the pose graph optimizer. For example, the optimization techniques may combine the transformation matrices 497, 498, 499 based on comparisons between the point clouds 478, 480 (such as comparisons between the correspondences 494, 495, 496, comparisons between the transformation matrices 497, 498, 499, or combinations thereof). As another example, the optimization techniques may combine the transformation matrices 497, 498, 499 based on measurements within the same point cloud (such as based on portions of different transformation matrices 497, 498, 499 that correspond to the same portion of a point cloud 478, 480). In certain implementations, the pose graph optimization may be performed using one or more software libraries (such as a ceres software library, a g2o software library, or combinations thereof).

The computing device 472 may be configured to determine a combined point cloud for an area containing the at least two different positions based on the transformation matrix 473, the first point cloud 478, and the second point cloud 480. For example, the combined transformation matrix 473 may be an exemplary implementation of the transformation matrix 412 and may be used to determine the combined point cloud 414 for the system 400 using the techniques discussed above.

The above-described techniques may improve the correction of errors in positional information within point clouds, such as the positional errors that may be caused by scale drift. Furthermore, these techniques preserve internal consistency within transformation matrices, which may help improve the quality of interior relations and positions between objects within point clouds. Such techniques accordingly enable more accurate positional information within combined point clouds, enabling more accurate representations of physical environments for subsequent use in vehicle applications. Furthermore, by adaptively sizing each window within the point clouds, these techniques reduce the overall amount of computing resources necessary to acquire accurate comparisons between windows, enabling more efficient processing of point clouds with internally varying point densities.

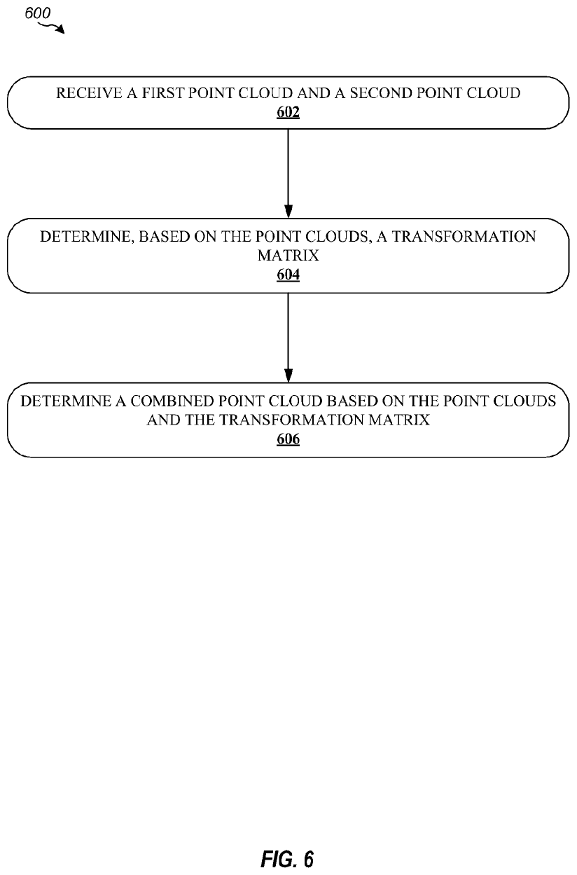

One method of performing image processing according to embodiments described above is shown in FIG. 6. FIG. 6 is a flow chart illustrating an example method 600 for aligning and combining point clouds according to an exemplary embodiment of the present disclosure. The method 600 may be performed by one or more of the above systems, such as the systems 100, 200, 300, 400, 420, 470.

The method 600 includes receiving a first point cloud and a second point cloud (block 602). For example, the computing device 402 may receive a first point cloud 404 and a second point cloud 406. The first and second point clouds 404, 406 may captured from at least two different positions 408, 410, such as along two or more different trajectories through a scene.

The method 600 includes determining, based on the point clouds, a transformation matrix (block 604). For example, the computing device 402 may determine, based on the point clouds 404, 406, a transformation matrix 412. In certain implementations, the transformation matrix 412 may be determined according to one or more of the techniques discussed above. For example, the transformation matrix 412 may be determined based on categories and weights corresponding to points within the point clouds 404, 406. As another example, the transformation matrix 412 may be determined based on windows of corresponding points from the point clouds 404, 406. In various implementations, the transformation matrix 412 may be determined by performing at least one of the methods 700, 800, described further below.

The method 600 includes determining a combined point cloud based on the point clouds and the transformation matrix (block 606). For example, the computing device 402 may determine a combined point cloud 414 based on the point clouds 404 and the transformation matrix 412. In certain implementations, the computing device 402 may determine an aligned point cloud 416 by applying the transformation matrix 412 to the first point cloud 404, and the aligned point cloud 416 may be aligned with the second point cloud 406. In additional or alternative implementations, the computing device 402 may apply the transformation matrix 412 to both point clouds 404, 406 to generate aligned point clouds 416, 418 that are aligned with one another. The aligned point clouds may then be combined to form the combined point cloud 414.

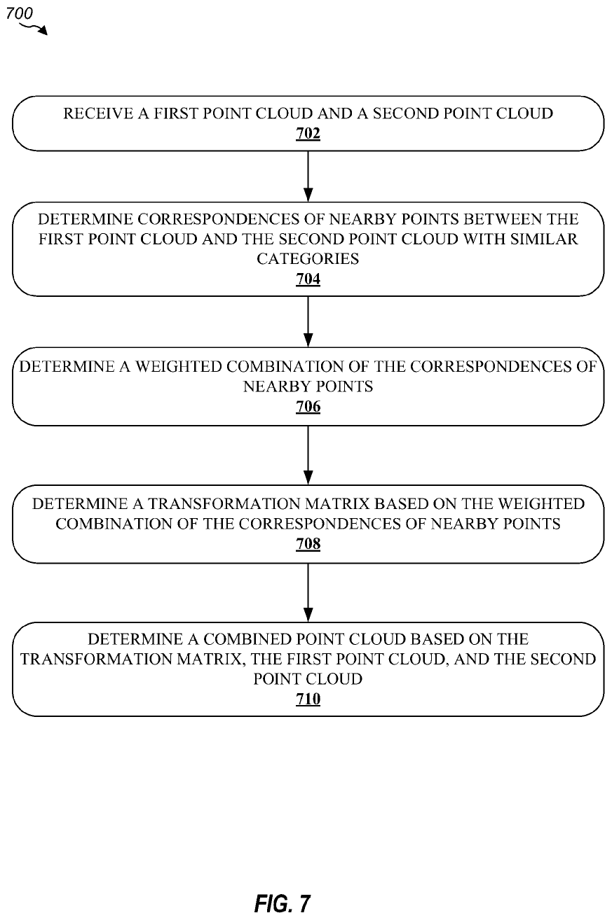

One method of performing image processing according to embodiments described above is shown in FIG. 7. FIG. 7 is a flow chart illustrating an example method 700 for aligning and combining point clouds according to an exemplary embodiment of the present disclosure. The method may be performed by one or more of the above systems, such as the systems 100, 200, 300, 400, 420, 470.

The method 700 includes receiving a first point cloud and a second point cloud (block 702). For example, the computing device 422 may receive a first point cloud 424 and a second point cloud 426. The first and second point clouds 424, 426 may be captured from at least two different positions, such as two different positions within a scene depicted by the point clouds 424, 426. In certain implementations, the first and second point clouds 424, 426 may contain points 428, 430, 432, 434 with corresponding semantic information 436, 438, 440, 442. In such implementations, the semantic information 436, 438, 440, 442 may include information regarding objects whose positions are indicated by the corresponding points 428, 430, 432, 434. In certain implementations, the semantic information 436, 438, 440, 442 may indicate one or more corresponding categories or other identifiers of objects located at the measured positions used to generate the points 428, 430, 432, 434 within the point cloud.

The method 700 includes determining correspondences of nearby points between the first point cloud and the second point cloud (block 704). For example, the computing device 422 may determine correspondences 452, 454 of nearby points 428, 430, 432, 434 between the first point cloud 424 and the second point cloud 426. In certain implementations, the correspondences 452, 454 are identified to contain points 428, 430, 432, 434 from different point clouds 424, 426 whose semantic information 436, 438, 440, 442 indicate corresponding categories 448, 450. In certain implementations, corresponding categories 448, 450 include groups of one or more categories 448, 450 of objects identified by the semantic information 436, 438, 440, 442. In certain implementations, identifying the correspondences 452, 454 of nearby points 428, 430, 432, 434 includes determining, based on categories 448, 450 identified in the semantic information 436, 438, 440, 442, groups of points 428, 430, 432, 434 from the first point cloud 424 and the second point cloud 426 that have corresponding categories 448, 450. In certain implementations, each group of points 428, 430, 432, 434 has a corresponding category or categories 448, 450 (such as the same or similar categories 448, 450) and correspondences 452, 454 may be identified as between the first point cloud 424 and the second point cloud 426 from the same group. In certain implementations, the correspondences of nearby points 428, 430, 432, 434 are determined using an iterative closest points 428, 430, 432, 434 (ICP) analysis.

The method 700 includes determining a weighted combination of the correspondences of nearby points (block 706). For example, the computing device 422 may determine a weighted combination of the correspondences 452, 454 of nearby points 428, 430, 432, 434. The weights 444, 446 for the correspondences 452, 454 may be determined based on the corresponding categories 448, 450 for the points 428, 430, 432, 434 contained within the correspondences 452, 454. In certain implementations, the weights 444, 446 are selected from a predetermined set of weights corresponding to each of the groups of categories 448, 450.

The method 700 includes determining a transformation matrix based on the weighted combination of the correspondences of nearby points (block 708). For example, the computing device 422 may determine a transformation matrix 462 based on the weighted combination of the correspondences 452, 454 of nearby points 428, 430, 432, 434. In certain implementations, as explained further above, a transformation matrix 462 may be determined based on differences in positions between corresponding points within the correspondences 452, weighted according to the weights 444, 446. In additional or alternative implementations, transformation matrixes 456, 458 may be determined separately for individual groups of correspondences 452, 454, and may be combined to form the combined transformation matrix 462 based on the weights 444, 446.

The method 700 includes determining a combined point cloud based on the transformation matrix, the first point cloud, and the second point cloud (block 710). For example, the computing device 422 may determine a combined point cloud based on the transformation matrix 462, the first point cloud 424, and the second point cloud 426. For example, a combined point cloud may be determined according to one or more of the techniques discussed above in connection with block 606.

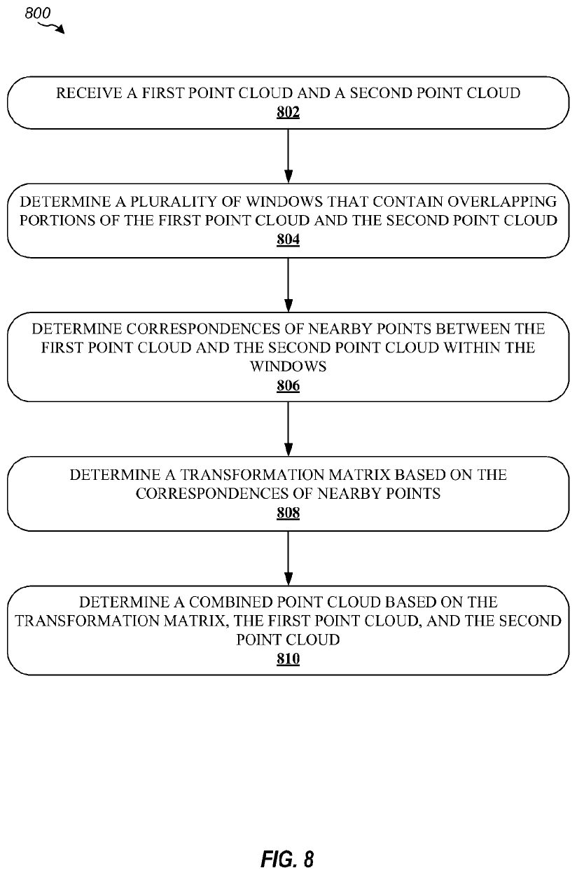

One method of performing image processing according to embodiments described above is shown in FIG. 8. FIG. 8 is a flow chart illustrating an example method 800 for aligning and combining point clouds according to an exemplary embodiment of the present disclosure. The method 800 may be performed by one or more of the above systems, such as the systems 100, 200, 300, 400, 420, 470.

The method 800 includes receiving a first point cloud and a second point cloud (block 802). For example, the computing device 472 may receive a first point cloud 478 and a second point cloud 480. The first and second point clouds 478, 480 may be captured from at least two different positions. In certain implementations, the point clouds 478, 480 may be received with snippets 474, 476 that contain the point clouds 478, 480 and key frames 486, 488.

The method 800 includes determining a plurality of windows that contain overlapping portions of the first point cloud and the second point cloud (block 804). For example, the computing device 472 may determine a plurality of windows 490, 491, 493 that contain overlapping portions of the first point cloud 478 and the second point cloud 480. In certain implementations, determining the plurality of windows 490, 491, 493 may include determining a first window 490 that contains overlapping portions of the first point cloud 478 and the second point cloud 480 that each contain more than a predetermined number of points 482, 484. In certain implementations, a first portion of the first point cloud 478 may overlap with a second portion of the second point cloud 480, and both the first portion and the second portion may be determined as containing more than a predetermined number of points 482, 484. In certain implementations, the computing device 472 may also determine that the points 482, 484 are evenly distributed between the first portion and the second portion. In certain implementations, the first window 490 may be identified as the smallest combination of overlapping portions of the first point cloud 478 and the second point cloud 480 that each contain more than the predetermined number of points 482, 484. In certain implementations, the computing device 472 may determine additional windows 491, 493 that contain different overlapping portions of the first point cloud 478 and the second point cloud 480 based on the first window 490. In certain implementations, at least one of the additional windows 491, 493 differs in size from the first window 490.

The method 800 includes determining correspondences of nearby points between the first point cloud and the second point cloud (block 806). For example, the computing device 472 may determine correspondences 494, 495, 496 of nearby points 482, 484 between the first point cloud 478 and the second point cloud 480. The correspondences 494, 495, 496 may contain points 482, 484 from the same window of the plurality of windows 490, 491, 493. In certain implementations, determining the correspondences 494, 495, 496 of nearby points 482, 484 may include determining, for each respective window of the plurality of windows 490, 491, 493, correspondences 494, 495, 496 by identifying closest points 482, 484 between the first point cloud 478 and the second point cloud 480 within the respective window 490, 491, 493.

The method 800 includes determining a transformation matrix based on the correspondences of nearby points (block 808). For example, the computing device 472 may determine a transformation matrix 473 based on the correspondences 494, 495, 496 of nearby points 482, 484. In certain implementations, determining the transformation matrix includes determining a first subset of the correspondences 494 from points within the first window 490 and determining a first transformation matrix 499 based on the first subset of the correspondences 494. In certain implementations, a second subset of the correspondences 495 from points within a second window 491 may be identified, and the first transformation matrix 499 may be applied to the second subset of the correspondences 495.

In certain implementations, determining the transformation matrix 473 may include determining a plurality of transformation matrices 497, 498, 499 corresponding to the plurality of windows 490, 491, 493. The computing device 472 may then determine comparisons between adjacent transformation matrices 497, 498, 499 of the plurality of transformation matrices 497, 498, 499. The adjacent transformation matrices 497, 498, 499 correspond to adjacent windows 490, 491, 493 of the plurality of windows 490, 491, 493. The computing device 472 may remove at least a subset of the transformation matrices 497, 498, 499 based on the comparisons.

The method 800 includes determining a combined point cloud based on the transformation matrix, the first point cloud, and the second point cloud (block 810). For example, the computing device 472 may determine a combined point cloud based on the transformation matrix 473, the first point cloud 478, and the second point cloud 480. For example, a combined point cloud may be determined according to one or more of the techniques discussed above in connection with block 606.

It is noted that one or more blocks (or operations) described with reference to FIGS. 6-8 may be combined with one or more blocks (or operations) described with reference to another of the figures. For example, one or more blocks (or operations) of FIG. 6 may be combined with one or more blocks (or operations) of FIG. 1-4. As another example, one or more blocks associated with FIG. 7 may be combined with one or more blocks associated with FIG. 8.

In one or more aspects, techniques for supporting vehicular operations may include additional aspects, such as any single aspect or any combination of aspects described below or in connection with one or more other processes or devices described elsewhere herein. A first aspect includes a method that includes receiving a first point cloud and a second point cloud, where the first and second point clouds are captured from at least two different positions. The method also includes determining, based on the first and second point clouds, a transformation matrix. The method also includes determining an aligned point cloud by applying the transformation matrix to the first point cloud, where the aligned point cloud is aligned with the second point cloud. The method also includes determining a combined point cloud for an area containing the at least two different positions based on the aligned point cloud and the second point cloud. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the first and second point clouds contain points with corresponding semantic information. Determining the transformation matrix may include determining correspondences of nearby points between the first point cloud and the second point cloud, where the correspondences are identified to contain points whose semantic information indicate corresponding categories. Determining the transformation matrix may further include determining a weighted combination of the correspondences of nearby points, where weights for the correspondences are determined based on the corresponding categories for the points contained within the correspondences, and determining a transformation matrix based on the weighted combination of the correspondences of nearby points.

In a third aspect, in combination with the second aspect, determining the correspondences of nearby points may include determining, based on categories identified in the semantic information, groups of points from the first point cloud and the second point cloud that have corresponding categories; and determining, for each of respective group of the groups of points, correspondences by identifying closest points between the first point cloud and the second point cloud from the respective group.

In a fourth aspect, in combination with one or more of the first aspect through the third aspect, determining the transformation matrix may include determining a plurality of windows that contain overlapping portions of the first point cloud and the second point cloud; determining additional windows that contain different overlapping portions of the first point cloud and the second point cloud based on the first window; determining correspondences of nearby points between the first point cloud and the second point cloud, where the correspondences contain points from a single window of the plurality of windows; and determining a transformation matrix based on the correspondences of nearby points.

In a fifth aspect, in combination with the fourth aspect, determining the plurality of windows includes determining a first window that contains overlapping portions of the first point cloud and the second point cloud that each contain more than a predetermined number of points.

A sixth aspect includes a method that includes receiving a first point cloud and a second point cloud, where the first and second point clouds are captured from at least two different positions, and where the first and second point clouds contain points with corresponding semantic information. The method also includes determining correspondences of nearby points between the first point cloud and the second point cloud, where the correspondences are identified to contain points whose semantic information indicate corresponding categories. The method also includes determining a weighted combination of the correspondences of nearby points, where weights for the correspondences are determined based on the corresponding categories for the points contained within the correspondences. The method also includes determining a transformation matrix based on the weighted combination of the correspondences of nearby points. The method also includes determining a combined point cloud based on the transformation matrix, the first point cloud, and the second point cloud.

In a seventh aspect, in combination with the sixth aspect, the semantic information includes information regarding objects whose positions are indicated by the corresponding points.

In an eighth aspect, in combination with the seventh aspect, corresponding categories include groups of one or more categories of objects identified by the semantic information.

In a ninth aspect, in combination with the eighth aspect, determining the correspondences of nearby points may include: determining, based on categories identified in the semantic information, groups of points from the first point cloud and the second point cloud that have corresponding categories; determining, for each of respective group of the groups of points, correspondences by identifying closest points between the first point cloud and the second point cloud from the respective group.

In a tenth aspect, in combination with the ninth aspect, the correspondences of nearby points are determined using an iterative closest points (ICP) analysis.

In an eleventh aspect, in combination with one or more of the eighth aspect through the tenth aspect, the weights are selected from a predetermined set of weights corresponding to each of the groups of categories.

In an twelfth aspect, in combination with one or more of the sixth aspect through the eleventh aspect, the weights reflect a relative positional accuracy of points corresponding to different types of objects.

In a thirteenth aspect, in combination with one or more of the sixth aspect through the eleventh aspect, determining the combined point cloud may include determining an aligned point cloud by applying the transformation matrix to the first point cloud, where the aligned point clouds is aligned with the second point cloud; and determining the combined point cloud for an area containing the at least two different positions based on the aligned point cloud and the second point cloud.

In a fourteenth aspect, in combination with one or more of the sixth aspect through the thirteenth aspect, the semantic information includes information regarding objects whose positions are indicated by the corresponding points.

A fifteenth aspect includes an apparatus that includes includes a memory storing processor-readable code and at least one processor coupled to the memory. The at least one processor is configured to execute the processor-readable code to cause the at least one processor to perform operations including receiving a first point cloud and a second point cloud, where the first and second point clouds are captured from at least two different positions, and where the first and second point clouds contain points with corresponding semantic information. The operations also include determining correspondences of nearby points between the first point cloud and the second point cloud, where the correspondences are identified to contain points whose semantic information indicate corresponding categories. The operations also include determining a weighted combination of the correspondences of nearby points, where weights for the correspondences are determined based on the corresponding categories for the points contained within the correspondences. The operations also include determining a transformation matrix based on the weighted combination of the correspondences of nearby points. The operations also include determining a combined point cloud based on the transformation matrix, the first point cloud, and the second point cloud.

In a sixteenth aspect, in combination with the fifteenth aspect, the semantic information includes information regarding objects whose positions are indicated by the corresponding points.

In a seventeenth aspect, in combination with the sixteenth aspect, corresponding categories include groups of one or more categories of objects identified by the semantic information.

In an eighteenth aspect, in combination with the seventeenth aspect, determining the correspondences of nearby points may include determining, based on categories identified in the semantic information, groups of points from the first point cloud and the second point cloud that have corresponding categories; determining, for each of respective group of the groups of points, correspondences by identifying closest points between the first point cloud and the second point cloud from the respective group.

In a nineteenth aspect, in combination with the eighteenth aspect, the correspondences of nearby points are determined using an iterative closest points (ICP) analysis.

In a twentieth aspect, in combination with one or more of the seventeenth aspect through the nineteenth aspect, the weights are selected from a predetermined set of weights corresponding to each of the groups of categories.

A twenty-first aspect includes a method that includes receiving a first point cloud and a second point cloud, where the first and second point clouds are captured from at least two different positions. The method also includes determining a plurality of windows that contain overlapping portions of the first point cloud and the second point cloud. The method also includes determining additional windows that contain different overlapping portions of the first point cloud and the second point cloud based on the first window. The method also includes determining correspondences of nearby points between the first point cloud and the second point cloud, where the correspondences contain points from a single window of the plurality of windows. The method also includes determining a transformation matrix based on the correspondences of nearby points. The method also includes determining a combined point cloud based on the transformation matrix, the first point cloud, and the second point cloud.

In a twenty-second aspect, in combination with the twenty-first aspect, determining the plurality of windows includes determining a first window that contains overlapping portions of the first point cloud and the second point cloud that each contain more than a predetermined number of points.

In a twenty-third aspect, in combination with the twenty-second aspect, the first window is identified as a smallest combination of overlapping portions of the first point cloud and the second point cloud that each contain more than the predetermined number of points.

In a twenty-fourth aspect, in combination with the twenty-third aspect, determining the transformation matrix may include determining a first subset of the correspondences from points within the first window; determining a first transformation matrix based on the first subset of the correspondences; and determining a second subset of the correspondences from points within a second window of the plurality of windows based on the first transformation matrix.

In a twenty-fifth aspect, in combination with one or more of the twenty-second aspect through the twenty-fourth aspect, the additional windows are identified for as overlapping portions of the first point cloud and the second point cloud that each contain more than the predetermined number of points.

In a twenty-sixth aspect, in combination with one or more of the twenty-first aspect through the twenty-fifth aspect, determining the correspondences of nearby points includes determining, for each respective window of the plurality of windows, correspondences by identifying closest points between the first point cloud and the second point cloud within the respective window.

In a twenty-seventh aspect, in combination with the twenty-sixth aspect, the correspondences of nearby points are determined using an iterative closest points (ICP) analysis.

In a twenty-eighth aspect, in combination with one or more of the twenty-first aspect through the twenty-seventh aspect, the adjacent transformation matrices correspond to adjacent windows of the plurality of windows; and removing at least a subset of the transformation matrices based on the comparisons.

In a twenty-ninth aspect, in combination with the twenty-eighth aspect, the method may include determining, using a pose graph optimizer, the transformation matrix based on the plurality of transformation matrices, the first point cloud, and the second point cloud.

In a thirtieth aspect, in combination with one or more of the twenty-first aspect through the twenty-ninth aspect, determining the combined point cloud may include determining an aligned point cloud by applying the transformation matrix to the first point cloud, where the aligned point clouds is aligned with the second point cloud; and determining the combined point cloud for an area containing the at least two different positions based on the aligned point cloud and the second point cloud.

A thirty-first aspect includes a non-transitory computer-readable medium storing instructions that, when executed by a processor, cause the processor to perform operations that include receiving a first point cloud and a second point cloud where the first and second point clouds are captured from at least two different positions. The operations also include determining a plurality of windows that contain overlapping portions of the first point cloud and the second point cloud. The operations also include determining additional windows that contain different overlapping portions of the first point cloud and the second point cloud based on the first window. The operations also include determining correspondences of nearby points between the first point cloud and the second point cloud, where the correspondences contain points from a single window of the plurality of windows. The operations also include determining a transformation matrix based on the correspondences of nearby points. The operations also include determining a combined point cloud based on the transformation matrix, the first point cloud, and the second point cloud.

In a thirty-second aspect, in combination with the thirty-first aspect, determining the plurality of windows includes determining a first window that contains overlapping portions of the first point cloud and the second point cloud that each contain more than a predetermined number of points.

In a thirty-third aspect, in combination with the thirty-second aspect, the first window is identified as a smallest combination of overlapping portions of the first point cloud and the second point cloud that each contain more than the predetermined number of points.

In a thirty-fourth aspect, in combination with the thirty-third aspect, determining the transformation matrix may include: determining a first subset of the correspondences from points within the first window; determining a first transformation matrix based on the first subset of the correspondences; and determining a second subset of the correspondences from points within a second window of the plurality of windows based on the first transformation matrix.

In a thirty-fifth aspect, in combination with one or more of the thirty-second aspect through the thirty-fourth aspect, the additional windows are identified for as overlapping portions of the first point cloud and the second point cloud that each contain more than the predetermined number of points.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method comprising:
receiving a first point cloud and a second point cloud, wherein the first and second point clouds are captured from at least two different positions;
determining, based on the first and second point clouds, a transformation matrix;
determining an aligned point cloud by applying the transformation matrix to the first point cloud, wherein the aligned point cloud is aligned with the second point cloud; and
determining a combined point cloud for an area containing the at least two different positions based on the aligned point cloud and the second point cloud.

2. The method of claim 1, wherein the first and second point clouds contain points with corresponding semantic information, and wherein determining the transformation matrix comprises:
determining correspondences of nearby points between the first point cloud and the second point cloud, wherein the correspondences are identified to contain points whose semantic information indicate corresponding categories;
determining a weighted combination of the correspondences of nearby points, wherein weights for the correspondences are determined based on the corresponding categories for the nearby points contained within the correspondences; and
determining a transformation matrix based on the weighted combination of the correspondences of nearby points.

3. The method of claim 2, wherein determining the correspondences of nearby points comprises:
determining, based on categories identified in the semantic information, groups of points from the first point cloud and the second point cloud that have corresponding categories; and
determining, for each of respective group of the groups of points, correspondences by identifying closest points between the first point cloud and the second point cloud from the respective group.

4. The method of claim 1, wherein determining the transformation matrix comprises:
determining a plurality of windows that contain overlapping portions of the first point cloud and the second point cloud;
determining correspondences of nearby points between the first point cloud and the second point cloud, wherein the correspondences contain points from a single window of the plurality of windows; and
determining a transformation matrix based on the correspondences of nearby points.

5. The method of claim 4, wherein determining the plurality of windows includes determining a first window that contains overlapping portions of the first point cloud and the second point cloud that each contain more than a predetermined number of points.

6-13. (canceled)

14. An apparatus, comprising:
a memory storing processor-readable code; and
at least one processor coupled to the memory, the at least one processor configured to execute the processor-readable code to cause the at least one processor to perform operations including:
receiving a first point cloud and a second point cloud, wherein the first and second point clouds are captured from at least two different positions, and wherein the first and second point clouds contain points with corresponding semantic information;
determining correspondences of nearby points between the first point cloud and the second point cloud, wherein the correspondences are identified to contain points whose semantic information indicate corresponding categories;
determining a weighted combination of the correspondences of nearby points, wherein weights for the correspondences are determined based on the corresponding categories for the nearby points contained within the correspondences;
determining a transformation matrix based on the weighted combination of the correspondences of nearby points; and
determining a combined point cloud based on the transformation matrix, the first point cloud, and the second point cloud.

15. The apparatus of claim 14, wherein the semantic information includes information regarding objects whose positions are indicated by the corresponding points.

16. The apparatus of claim 15, wherein corresponding categories include groups of one or more categories of objects identified by the semantic information.

17. The apparatus of claim 16, wherein determining the correspondences of nearby points comprises:
determining, based on categories identified in the semantic information, groups of points from the first point cloud and the second point cloud that have corresponding categories; and
determining, for each of respective group of the groups of points, correspondences by identifying closest points between the first point cloud and the second point cloud from the respective group.

18. The apparatus of claim 17, wherein the correspondences of nearby points are determined using an iterative closest points (ICP) analysis.

19. The apparatus of claim 16, wherein the weights are selected from a predetermined set of weights corresponding to each of the groups of categories.

20. A method comprising:
receiving a first point cloud and a second point cloud wherein the first and second point clouds are captured from at least two different positions;
determining a plurality of windows that contain overlapping portions of the first point cloud and the second point cloud;
determining correspondences of nearby points between the first point cloud and the second point cloud, wherein the correspondences contain points from a single window of the plurality of windows;
determining a transformation matrix based on the correspondences of nearby points; and
determining a combined point cloud based on the transformation matrix, the first point cloud, and the second point cloud.

21. The method of claim 20, wherein determining the plurality of windows includes determining a first window that contains overlapping portions of the first point cloud and the second point cloud that each contain more than a predetermined number of points.

22. The method of claim 21, wherein the first window is identified as a smallest combination of overlapping portions of the first point cloud and the second point cloud that each contain more than the predetermined number of points.

23. The method of claim 22, wherein determining the transformation matrix comprises:
determining a first subset of the correspondences from points within the first window;
determining a first transformation matrix based on the first subset of the correspondences; and
determining a second subset of the correspondences from points within a second window of the plurality of windows based on the first transformation matrix.

24. The method of claim 21, further comprising determining additional windows of the plurality of windows as overlapping portions of the first point cloud and the second point cloud that each contain more than the predetermined number of points.

25. The method of claim 20, wherein determining the correspondences of nearby points includes determining, for each respective window of the plurality of windows, correspondences by identifying closest points between the first point cloud and the second point cloud within the respective window.

26. (canceled)

27. The method of claim 20, further comprising:
determining a plurality of transformation matrices corresponding to the plurality of windows;
determining comparisons between adjacent transformation matrices of the plurality of transformation matrices, wherein the adjacent transformation matrices correspond to adjacent windows of the plurality of windows; and
removing at least a subset of the transformation matrices based on the comparisons.

28. The method of claim 27, further comprising determining, using a pose graph optimizer, the transformation matrix based on the plurality of transformation matrices, the first point cloud, and the second point cloud.

29. The method of claim 20, wherein determining the combined point cloud comprises:
determining an aligned point cloud by applying the transformation matrix to the first point cloud, wherein the aligned point clouds is aligned with the second point cloud; and
determining the combined point cloud for an area containing the at least two different positions based on the aligned point cloud and the second point cloud.

30-35. (canceled)
